(19) United States
(12) Patent Application Publication
(10) Pub. No.: US 2026/0131637 A1
(43) Pub. Date: May 14, 2026

(54) HEATING, VENTILATION AND AIR CONDITIONING UNIT

(71) Applicant: VALEO SYSTEMES THERMIQUES, La Verriere (FR)

(72) Inventors: Jonathan YESTREPSKY, Auburn Hills, MI (US); Tudor RAVINEALA, Auburn Hills, MI (US); Joshua BARCZEWSKI, Auburn Hills, MI (US)

(73) Assignee: VALEO SYSTEMES THERMIQUES, La Verriere (FR)

(21) Appl. No.: 18/947,863

(22) Filed: Nov. 14, 2024

(51) Int. Cl. B60H 1/34

(52) U.S. Cl. CPC B60H 1/3421

(57) ABSTRACT

A heating, ventilation and air conditioning unit including: a case defining a first aperture arranged to receive a recirculation airflow, a second aperture arranged to receive a fresh air airflow, a third aperture arranged to evacuate air from the case, and a door configured to move between a first position, in which the first aperture is closed by the door with the second aperture being open, and a second position in which the first aperture is fully open and the second aperture is closed by the door. The first aperture is covered by a grid with a diffuser rib.

### TECHNICAL FIELD

Invention relates to a heating, ventilation and air conditioning (HVAC) unit, in particular to a case of such unit, for example applicable to the automotive field.

### BACKGROUND OF THE INVENTION

In vehicle environments, HVAC systems must effectively control and balance air intake from external sources, i.e. fresh air, and internal sources, i.e. recirculated air, to provide optimal cabin comfort, air quality, and energy efficiency under variable driving conditions. Traditional vehicle HVAC systems often encounter challenges in efficiently mixing fresh and recirculated air, as well as maintaining effective filtration and pressure balance, leading to potential compromises in air quality, system efficiency and passengers'comfort.

### SUMMARY OF THE INVENTION

An object of the invention is a heating, ventilation and air conditioning unit comprising a case defining a first aperture arranged to receive a recirculation airflow, a second aperture arranged to receive a fresh air airflow, a third aperture arranged to evacuate air from the case, and a door configured to move between a first position, in which the first aperture is closed by the door with the second aperture being open, and a second position in which the first aperture is fully open and the second aperture is closed by the door; wherein the first aperture is covered by a grid with a diffuser rib.

In one example, the diffuser rib is in form of an attachment fixed to the case.

In one example, the first aperture has a bottom edge and a top edge, with the diffuser rib being lined along at least a portion of the top edge.

In one example, the diffuser rib is split into a plurality of segments.

In one example, the first aperture includes a central section and a first side section.

In one example, the central section includes a first central section portion and a second central section portion separated from each other by a divider section.

In one example, the top edge of the first central section portion includes a first central segment of the diffuser rib and the top edge of the second central section portion includes a second central segment of the diffuser rib.

In one example, the top edge of the first side section includes a first side segment of the diffuser rib.

In one example, the first aperture includes a second side section.

In one example, the top edge of the second side section includes a second side segment of the diffuser rib.

In one example, the grid is formed by intersecting rods, wherein the diffuser rib includes cutouts for the intersecting rods.

In one example, the diffuser rib includes an elongated base and diffuser elements protruding from the elongated base.

In one example, the diffuser elements protrude into the grid so that area for the airflow by the top edge is uniformly decreased along the top edge.

In one example, the diffuser elements form a repeating pattern along the elongated base.

In one example, the diffuser elements form a non-repeating pattern along the elongated base.

In one example, the diffuser elements form a saw tooth pattern.

In one example, the diffuser elements form a castle wall pattern.

In one example, the first side segment and the second side segment of the diffuser rib are of different lengths.

### BRIEF DESCRIPTION OF DRAWINGS

The present invention will be described in greater detail below with reference to the drawings. In the drawings:

FIG. 1 shows a perspective view of the heating, ventilation and air conditioning unit according to the invention from above;

FIG. 2 shows a perspective view of the heating, ventilation and air conditioning unit of FIG. 1 from below;

FIG. 3 shows schematically cross-section of case of the heating, ventilation and air conditioning unit, with recirculation door in a first position where the fresh air can enter the unit;

FIG. 4 shows schematically cross-section of case of the heating, ventilation and air conditioning unit, with recirculation door in a second position where the recirculated air can enter the unit;

FIG. 5 shows a grid and with a diffuser rib in an isolated perspective view;

FIG. 6 shows the diffuser rib in an isolated perspective view;

FIG. 7 shows an example of the diffuser rib in a closer view;

FIG. 8 shows another example of the diffuser rib in a closer perspective view;

FIG. 9 shows the example of the diffuser rib of FIG. 8 from below;

FIG. 10 shows an isolated perspective view of the diffuser rib of FIG. 8;

FIG. 11 shows schematically an example of the diffuser rib pattern;

FIG. 12 shows schematically another example of the diffuser rib pattern;

FIG. 13 shows a first side segment of the diffuser rib;

FIG. 14 shows a second side segment of the diffuser rib;

FIG. 15 shows the first side segment of the diffuser rib from the outside of the case;

FIG. 16 shows the second side segment of the diffuser rib from the outside of the case;

FIG. 17 shows the first side segment of the diffuser rib from the inside of the case; and

FIG. 18 shows the second side segment of the diffuser rib from the inside of the case.

### DETAILED DESCRIPTION OF THE INVENTION

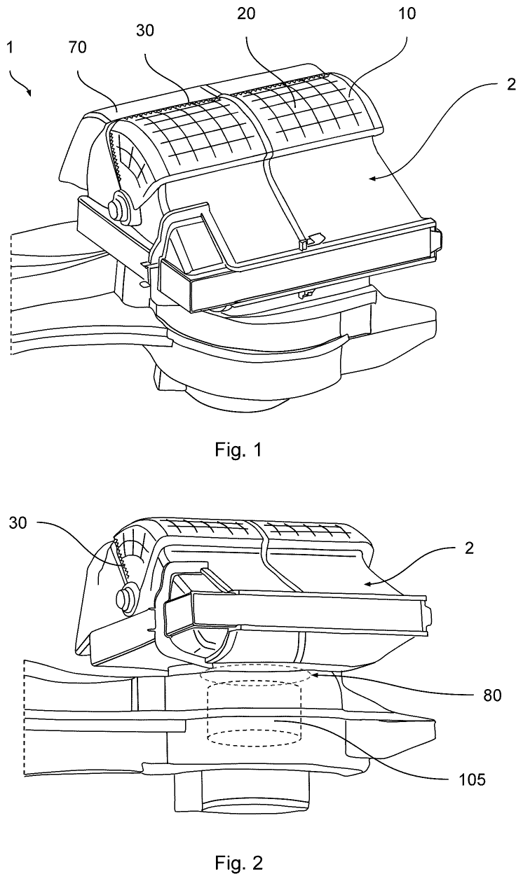

FIG. 1 shows a perspective view of the heating, ventilation and air conditioning unit 1 according to the invention from above, while FIG. 2 shows a perspective view of the heating, ventilation and air conditioning unit 1 of FIG. 1 from below.

A heating, ventilation and air conditioning unit 1, for example for a vehicle, can comprise a case 2. The case 2 can define a first aperture 10 arranged to receive a recirculation airflow, a second aperture 70 arranged to receive a fresh air airflow, and a third aperture 80 arranged to evacuate air from the case 2. The recirculation air can be drawn for example from footwell areas, central and/or rear cabin spaces, or from under the seats. The case 2 can include a blower 105, shown schematically in FIG. 2, to induce airflow into and out of the case 2. The first aperture 10 can be covered by a grid 20. The purpose of the grid 20 can be to more quickly cool down a vehicle in AC mode, to stop outdoor odors and pollen from entering the vehicle, and/or to stop exhaust fumes from other vehicles from entering when the vehicle is in traffic.

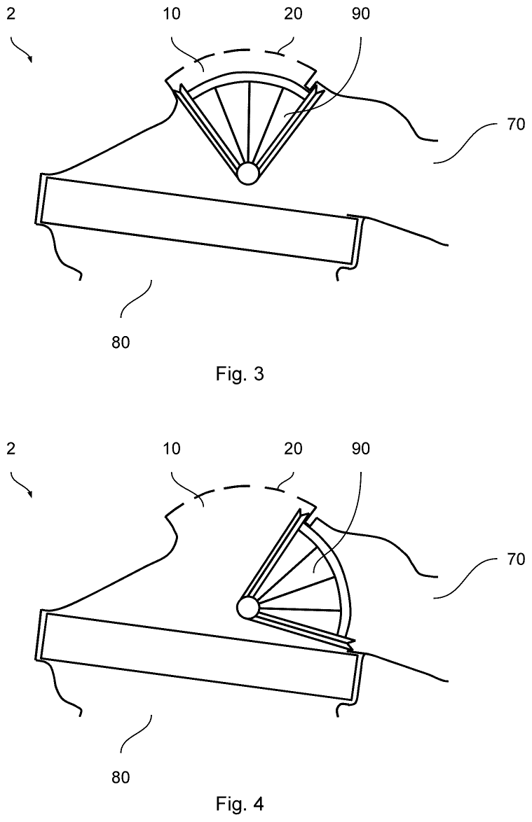

As shown in FIG. 2 and FIG. 3, the case 2 can include a recirculation door 90 to enable closing and opening of the first aperture 10 and opening and closing of the second aperture 70. The recirculation door can for example fully close the first aperture 10, while at the same time the second aperture 70 becomes fully open. In such case, the third aperture 80 evacuates only the recirculation air. The recirculation door can also fully open the first aperture 10, while at the same time the second aperture 70 becomes fully closed. In such case, the third aperture 80 evacuates only fresh air. In other words, a door 90 can be configured to move between a first position, in which the first aperture 10 is closed by the door 90 with the second aperture 70 being open (FIG. 3), and a second position in which the first aperture 10 is fully open and the second aperture 70 is closed by the door 90 (FIG. 4).

It can happen during vehicles movement that the second aperture 70 is subject to ram air. When the recirculation door 90 moves from the second position to the first position, a noise can be produced due to imbalance in pressure between the grid 20 and the second aperture 70. For example, the pressure at the grid 20 can be around 0 Pa, while the relative pressure at the second aperture 70 can be between 250 Pa and 500 Pa. This air rush noise has high intensity tones or whistles caused by high velocity air flowing through a thin cross-section. Such noise can be perceived as unpleasant. This can also occur with insufficient recirculation door 20 sealing when air can escape past the over molded door seal.

To alleviate this problem, the grid 20 covering the first aperture 10 can include a diffuser rib 30 as discussed below. In general, the diffuser rib 30 can help diffuse the incoming air and delay a pressure spike as the recirculation door 90 breaks off the seal plane of the second aperture 70. The diffuser rib 30 can effectively assist in dispersing whistle noises into a wider spectrum of noise, which can be more pleasant and less noticeable, for example to vehicle passengers when the heating, ventilation and air conditioning unit 1 is mounted in the vehicle.

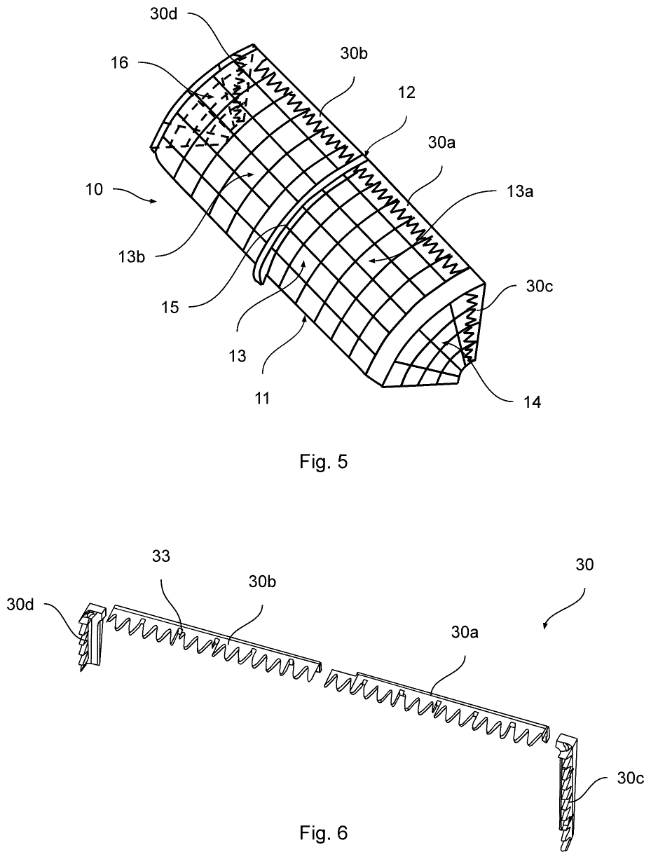

FIG. 5 shows the grid 20 and with a diffuser rib 30 in an isolated perspective view.

The first aperture 10 has a bottom edge 11 and a top edge 12, with the diffuser rib 30 being lined along at least a portion of the top edge 12. In this case, the top edge 12 is the edge located closer to the second aperture 70 than the bottom edge 12 is.

In general, the diffuser elements 32 extend along the first aperture 10 and/or grid 20, beyond the edges of the first aperture into its inner portion, so that they can affect the air flowing through them.

The first aperture 10 can include a central section 13 and a first side section 14. The central section 13 can include a first central section portion 13a and a second central section portion 13b separated from each other by a divider section 15. The divider section 15 can be provided to enhance rigidity of the case 2 or be a parting portion if the case 2 is made of several pieces.

The diffuser rib 30 can be split into a plurality of segments 30a, 30b, 30c, 30d, as it will be discussed further in relation to FIG. 6. In such case, the top edge 12 of the first central section portion 13a can include a first central segment 30a of the diffuser rib 30 and the top edge 12 of the second central section portion 13b a second central segment 30b of the diffuser rib 30. The top edge 12 of the first side section 14 can include a first side segment 30c of the diffuser rib 30.

The first aperture 10 can also include a second side section 16. The top edge 12 of the second side section 16 can ten include a second side segment 30d of the diffuser rib 30, preferably on the opposite side compared to the first side segment 30c of the first side section 14.

FIG. 6 shows the diffuser rib 30 in an isolated perspective view. The diffuser rib 30 can be in form of an attachment fixed to the case 2. Alternatively, the diffuser rib 30 can be an integral part of the

[symbol]

The first side segment 30c and the second side segment 30d of the diffuser rib 30 can be of different lengths. In this example, the first side section 14 has a longer top edge 12 compared with the top edge 12 of the second side section 16. The first side segment 30c and the second side segment 30d can then have corresponding lengths.

In general, the diffuser rib 30 can line the edges of the first aperture 10 which are closest to the second aperture 70.

The diffuser rib 30 can include an elongated base 31 and diffuser elements 32 protruding from the elongated base 31.

The diffuser elements 32 can protrude into the grid 20 so that area for the airflow by the top edge 12 is uniformly decreased along the top edge 12.

The diffuser elements 32 can form a repeating pattern along the elongated base 31.

Alternatively, the diffuser elements 32 can form a non-repeating pattern along the elongated base 31.

The diffuser elements 32 can form a saw tooth pattern. In other words, the diffuser elements 32 form a pattern mimicking a jagged shape of teeth of a saw blade. Each tooth of the pattern includes an ascending line (the rise) followed by a sloping line (the decline). Together, they form a series of peaks and troughs. Such teeth can be regular (identical) or non-regular (varying).

The diffuser elements 32 can form a castle wall pattern. In other words, the diffuser elements 32 form a pattern featuring alternating raised and lowered sections along the elongated base 31, resembling rectangular notches. The raised sections can be the diffuser elements 32, while the lowered sections can be spaces between them. The diffuser elements 32 can be of varying heights or same heights.

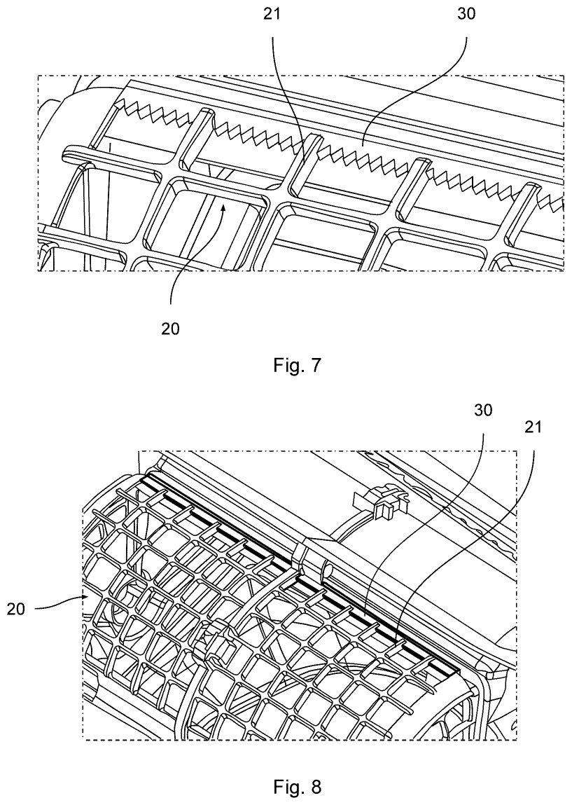

FIG. 7 shows an example of the diffuser rib 30 in a closer view. In this case, the diffuser elements 32 have an identical saw tooth shape forming a regular pattern.

As can be seen, the grid 20 is formed by intersecting rods 21. Preferably, the intersecting rods 21 intersect at right angles and at regular intervals. The diffuser rib 30 can include cutouts 33 for the intersecting rods 21. Thanks to such shape connection, the diffuser rib 30 can be securely fixed to the case 2.

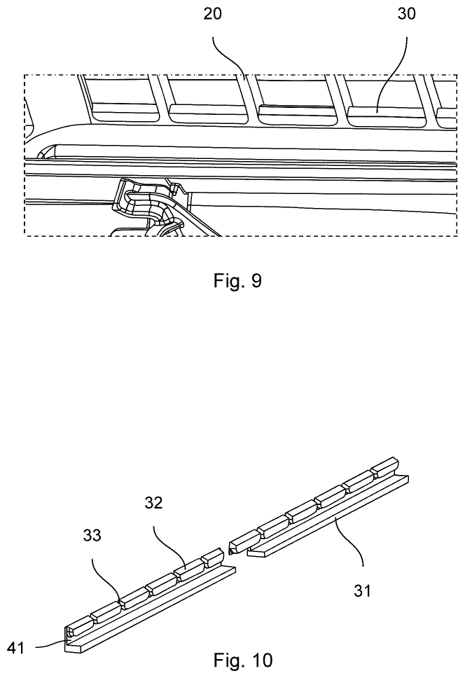

FIG. 8 shows another example of the diffuser rib 30 in a closer perspective view, with FIG. 9 showing the example of the diffuser rib 30 of FIG. 8 from below and FIG. 10 showing an isolated perspective view of the diffuser rib 30 of FIG. 8. In this example, the diffuser elements 32 are rectangular elements of identical shape, possibly with exception of the diffuser elements 32 adjacent the divider section 15 if needed to take account specific dimensioning constraints. The diffuser elements 32 can extend through the first aperture 10 to create a lip 41 engaging with the edge of the first aperture 10 to facilitate mounting.

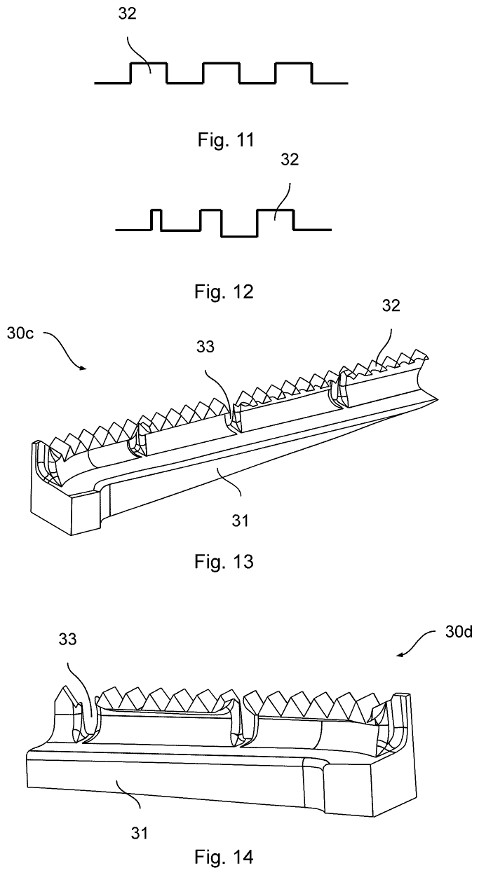

FIGS. 11 and 12 show schematically examples of the diffuser rib 30 pattern. As shown, the diffuser elements 32 can form a regular or irregular castle wall pattern that extends along selected edges of the first aperture 10.

FIG. 13 shows the first side segment 30c of the diffuser rib 30 in a perspective view, with FIG. 14 showing the second side segment 30d of the diffuser rib 30, also in perspective view. These can also include cutouts 33 for intersecting rods 21 of the first and second side sections 14, 16. The elongated base 31 can have a shape adapted to the grid 20 and the first aperture 10 exact shape. In this case, the elongated base 31 is sloping. What can also be seen is that some diffuser elements 32 have a broken shape in vicinity of the cutouts 33. In other words, the cutouts 33 cut not only though the elongated base 31 below the diffuser elements 32, but also through some of the diffuser elements 32 themselves, altering partly their shape.

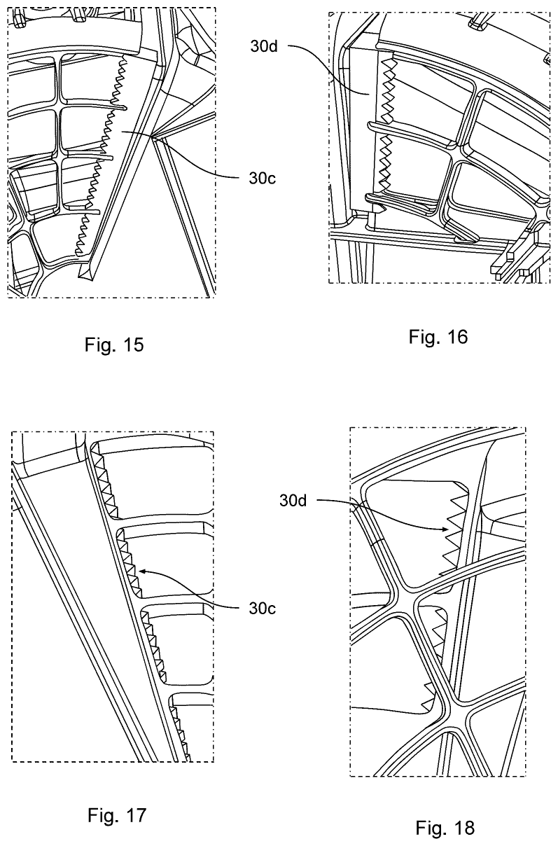

FIGS. 15 and 16 show respectively the first side segment 30c and the second side segment 30d of the diffuser rib 30 from the outside of the case 2., with FIGS. 17 and 18 showing respectively the first side segment 30c and the second side segment 30d of the diffuser rib 30 from the inside of the case 2. The elongated bases 31 are arranged on the outside of the case 2, with the diffuser elements 32 extending into the first and second sections 14, 16 so that they can affect the air flowing through them.

1. A heating, ventilation and air conditioning unit comprising:
a case defining a first aperture arranged to receive a recirculation airflow,
a second aperture arranged to receive a fresh air airflow,
a third aperture arranged to evacuate air from the case, and
a door configured to move between a first position, in which the first aperture is closed by the door with the second aperture being open, and a second position in which the first aperture is fully open and the second aperture is closed by the door;
wherein the first aperture is covered by a grid with a diffuser rib.

2. A heating, ventilation and air conditioning unit according to claim 1, wherein the diffuser rib is in form of an attachment fixed to the case.

3. A heating, ventilation and air conditioning unit according to claim 1, wherein the first aperture has a bottom edge and a top edge, with the diffuser rib being lined along at least a portion of the top edge.

4. A heating, ventilation and air conditioning unit according to claim 1, wherein the diffuser rib is split into a plurality of segments.

5. A heating, ventilation and air conditioning unit according to claim 1, wherein the first aperture includes a central section and a first side section.

6. A heating, ventilation and air conditioning unit 1 according to claim 1, wherein the central section includes a first central section portion and a second central section portion separated from each other by a divider section.

7. A heating, ventilation and air conditioning unit according to claim 1, wherein the top edge of the first central section portion includes a first central segment of the diffuser rib and the top edge of the second central section portion includes a second central segment of the diffuser rib.

8. A heating, ventilation and air conditioning unit according to claim 1, wherein the top edge of the first side section includes a first side segment of the diffuser rib.

9. A heating, ventilation and air conditioning unit according to claim 1, wherein the first aperture includes a second side section.

10. A heating, ventilation and air conditioning unit according to claim 1, wherein the top edge of the second side section includes a second side segment of the diffuser rib.

11. A heating, ventilation and air conditioning unit according to claim 1, wherein the grid is formed by intersecting rods, wherein the diffuser rib includes cutouts for the intersecting rods.

12. A heating, ventilation and air conditioning unit according to claim 1, wherein the diffuser rib includes an elongated base and diffuser elements protruding from the elongated base.

13. A heating, ventilation and air conditioning unit according to claim 11, wherein the diffuser elements protrude into the grid so that area for the airflow by the top edge is uniformly decreased along the top edge.

14. A heating, ventilation and air conditioning unit according to claim 11, wherein the diffuser elements form a repeating pattern along the elongated base.

15. A heating, ventilation and air conditioning unit according to claim 11, wherein the diffuser elements form a non-repeating pattern along the elongated base.

16. A heating, ventilation and air conditioning unit according to claim 11, wherein the diffuser elements form a saw tooth pattern.

17. A heating, ventilation and air conditioning unit according to claim 11, wherein the diffuser elements form a castle wall pattern.

18. A heating, ventilation and air conditioning unit according to claim 1, wherein the first side segment and the second side segment of the diffuser rib are of different lengths.
